(19) United States
(12) Patent Application Publication
(10) Pub. No.: US 2025/0007058 A1
(43) Pub. Date: Jan. 2, 2025

(54) METHOD FOR MANUFACTURING A RECHARGEABLE BATTERY PACK FOR A HANDHELD POWER TOOL

(71) Applicant: Hilti Aktiengesellschaft, Schaan (LI)

(72) Inventors: Robert STANGER, Kaufbeuren (DE); Markus HUNGER, Augsburg (DE)

(21) Appl. No.: 18/885,240

(22) Filed: Sep. 13, 2024

Related U.S. Application Data
(63) Continuation of application No. 16/764,010, filed on May 14, 2020.

(30) Foreign Application Priority Data
Dec. 19, 2017 (EP) 17208347.9

(51) Int. Cl. H01M 50/213; H01M 10/613; H01M 10/6235; H01M 10/6551

(52) U.S. Cl. CPC H01M 50/213; H01M 10/613; H01M 10/6235; H01M 10/6551; H01M 2220/30

(57) ABSTRACT

A method for manufacturing a rechargeable battery pack for an electric handheld power tool, wherein the rechargeable battery pack has a housing including a plurality of preferably cylindrical rechargeable battery cells, wherein the rechargeable battery cells are surrounded, at least in sections, by a thermally conductive potting material for the purpose of dissipating heat.

This is a Divisional of U.S. patent application Ser. No. 16/764,010 filed on May 14, 2020, published as US 2020/0335740 A, which is a National Stage of PCT/EP2018/081748, filed on Nov. 19, 2018, claiming priority to European Patent Application EP 17208347.9, filed on Dec. 19, 2017. All of the above are hereby incorporated by reference herein.

The present invention relates to a rechargeable battery pack for an electric handheld power tool, wherein the rechargeable battery pack has a housing comprising a plurality of preferably cylindrical rechargeable battery cells.

### BACKGROUND

A rechargeable battery pack of this kind is known, for example, from DE 10 2013 218 527 A1. The rechargeable battery cells of this rechargeable battery pack are thermally connected by means of an aluminum element for the purpose of dissipating heat.

### SUMMARY OF THE INVENTION

It is an object of the present invention to provide an alternative rechargeable battery pack for a handheld power tool, in particular one which facilitates an extended service life of the rechargeable battery cells.

The present invention provides that the rechargeable battery cells are surrounded, at least in sections, by a thermally conductive potting material for the purpose of dissipating heat.

The invention includes the finding that rechargeable battery packs which are known from the prior art and have heat-dissipating elements, in particular heat-dissipating elements composed of aluminum, are complicated to assemble and expensive to manufacture. Furthermore, comparatively poor transmission of heat from the rechargeable battery cells to the heat-dissipating element has been encountered in rechargeable battery packs of said kind. This is due, amongst other things, to manufacturing tolerances.

Since, according to the invention, the rechargeable battery cells are surrounded, at least in sections, by a thermally conductive potting material, these disadvantages are avoided.

The thermally conductive potting material is preferably introduced into the rechargeable battery pack in liquid form and then cured. Therefore, the rechargeable battery cells are surrounded, at least in sections, by the potting material and no cavities form between rechargeable battery cells and the housing, as a result of which comparatively good discharge of heat to the housing of the rechargeable battery pack is realized. Therefore, synergistically, the potting material assumes both the role of a thermally conductive element between the rechargeable battery cells and also between the rechargeable battery cells and the housing.

It has been found in rechargeable battery packs which are formed according to the invention that firstly the heat is rapidly dissipated to the outside and secondly is distributed uniformly within the rechargeable battery pack owing to the good thermal conductivity of the potting material. Therefore, the temperature level in the rechargeable battery pack can be kept comparatively low and all rechargeable battery cells are at virtually the same temperature during operation. This has the advantage, in particular, that an electric handheld power tool which is operated by the rechargeable battery pack according to the invention no longer has to be switched off on account of a previously disadvantageous temperature limit of the rechargeable battery cells. Therefore, the rechargeable battery cells are also uniformly thermally loaded.

It has been found to be advantageous when the potting material has a thermal conductivity of at least 1 W/(m-K) (W per meter-Kelvin). The thermal conductivity of the potting material can have at least 2 W/(m-K). The potting compound particularly preferably has a UL94 flammability rating of V-0.

The potting material can be based on polyurethane and is preferably an elastomer. The potting material is particularly preferably electrically insulating. The IEC 60093 resistivity of the potting material is preferably greater than 10 E10 Ω*cm, preferably greater than 10 E11 Ω*cm.

In a particularly preferred refinement, the potting material completely surrounds the rechargeable battery cells. Therefore, the discharge of heat, already mentioned in the introductory part, outward to the housing of the rechargeable battery pack is realized in the first instance. At the same time, the rechargeable battery pack is sealed off against dirt and moisture.

In a further preferred refinement, the rechargeable battery pack has a cell holder which holds the rechargeable battery cells within the housing. The cell holder preferably forms at least one delimited potting chamber within which the rechargeable battery cells are surrounded by the thermally conductive potting material.

It has been found to be advantageous when the potting chamber or the potting chambers are arranged close to a thermoelectric hotspot of the rechargeable battery cells or of a respective rechargeable battery cell.

The rechargeable battery cells are particularly preferably designed as lithium-polymer cells or as lithium-ion cells.

The filling material is particularly preferably free of a thermosetting plastic. The filling material is preferably an elastomer, and therefore mechanical stresses within the housing of the rechargeable battery pack can be compensated for. The no-load voltage of the rechargeable battery pack is particularly preferably limited to 60 V DC voltage.

### BRIEF DESCRIPTION OF THE DRAWINGS

Further advantages will become apparent from the following description of the figures. The figures illustrate various exemplary embodiments of the present invention. The figures, the description and the claims contain numerous features in combination. A person skilled in the art will expediently also consider the features individually and combine them to form expedient further combinations.

In the figures, identical components and components of the same type are designated by identical reference signs. In the figures:

FIG. 1 shows a first preferred exemplary embodiment of a rechargeable battery pack according to the invention;

FIG. 2 shows a side view of the exemplary embodiment of FIG. 1;

FIG. 3 shows a second preferred exemplary embodiment of a rechargeable battery pack according to the invention; and

FIG. 4 shows a third preferred exemplary embodiment of a rechargeable battery pack according to the invention.

### DETAILED DESCRIPTION

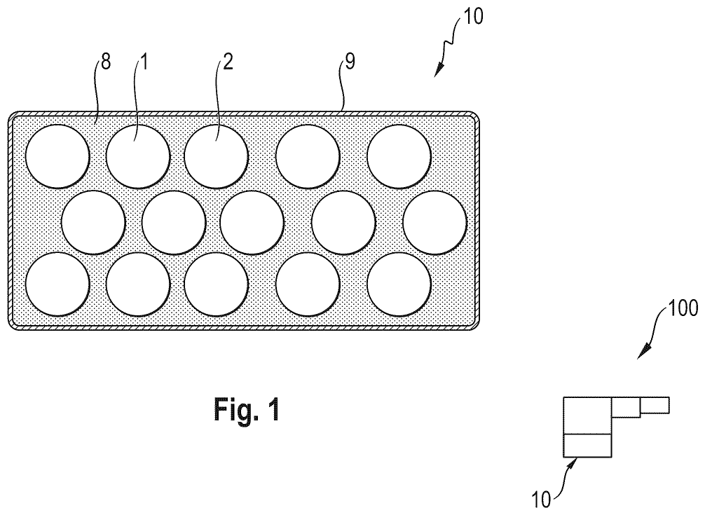

FIG. 1 shows a rechargeable battery pack 10 according to the invention for supplying electrical power to a handheld power tool 100 which is schematically illustrated at the bottom-right in FIG. 1. The rechargeable battery pack 10 has a housing 9 comprising a plurality of cylindrical rechargeable battery cells 1, 2. The rechargeable battery cells are surrounded by a thermally conductive potting material 8 for the purpose of dissipating heat.

In the present exemplary embodiment, the potting material 8 has a thermal conductivity of approximately 1 W/(m-K) and is based on polyurethane.

In the exemplary embodiment of FIG. 1, the potting material 8 is introduced into the housing 9 in such a way that it completely surrounds the rechargeable battery cells 1, 2.

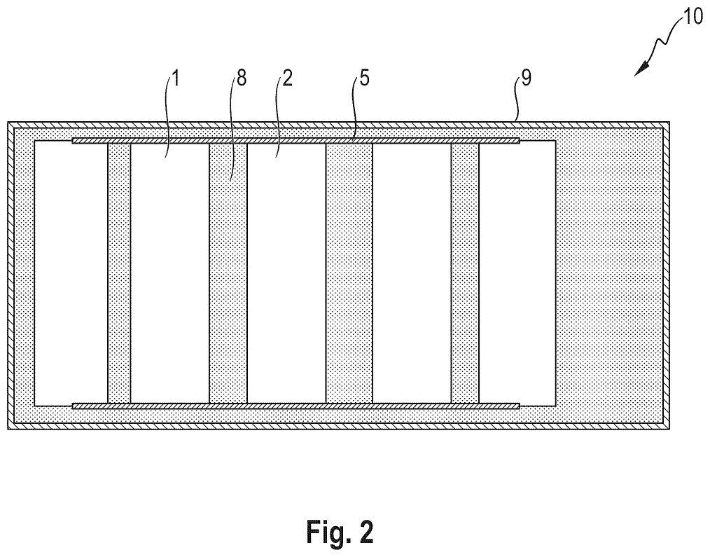

This can be seen particularly clearly in FIG. 2 which illustrates a side view of the exemplary embodiment of FIG. 1. The cylindrical rechargeable battery cells 1, 2 which are each in electrical contact with one another by means of a cell connector 5 can be clearly seen in FIG. 2.

The rechargeable battery pack 10 of FIG. 2 can be produced in such a way that a housing 9 in which the rechargeable battery cells 1, 2 are accommodated is initially provided. The potting material 8 is then introduced into the housing 9 in liquid form and then cured. Therefore, the lithium-polymer cells illustrated by way of example here are completely surrounded by the potting material 8, wherein uniform dissipation of heat is realized.

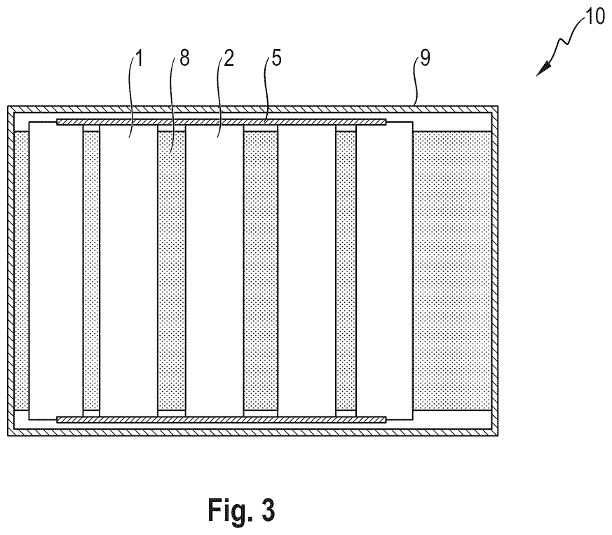

A second exemplary embodiment of a rechargeable battery pack 10 according to the invention is illustrated in FIG. 3. In comparison to the exemplary embodiment of FIG. 2, the thermally conductive potting material 8 gives the rechargeable battery cells 1, 2 only in sections. A predominant portion of the rechargeable battery cells 1, 2, in the exemplary embodiment illustrated in the present case approximately 90% with respect to the length of the rechargeable battery cells 1, 2, is surrounded by the potting material. The housing 9 is, and respectively the rechargeable battery cells 1, 2 are, free of potting material in the region of the cell connector 5 which electrically contact-connects the rechargeable battery cells 1, 2.

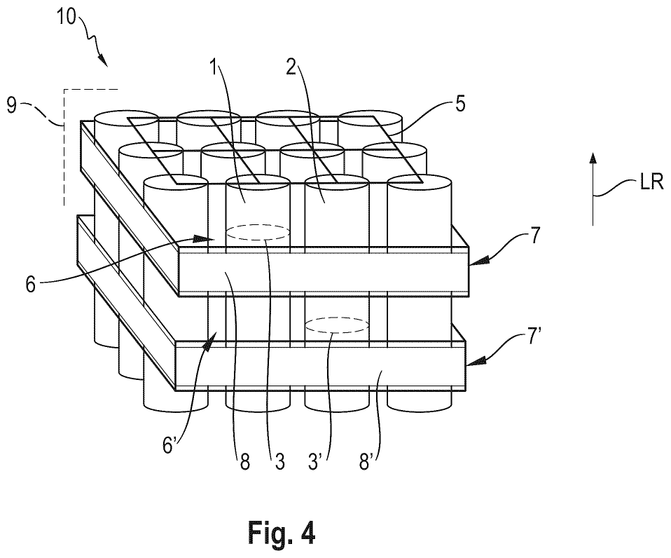

Finally, FIG. 4 shows a third exemplary embodiment of a rechargeable battery pack 10 according to the invention. Here, the housing 9 of the rechargeable battery pack 10 is merely schematically indicated by the dashed line.

The rechargeable battery pack 10 has a total of 12 cylindrical rechargeable battery cells 1, 2 in the form of lithium-ion cells. The rechargeable battery cells are electrically contact-connected to one another by the cell connector 5.

The rechargeable battery pack 10 has two cell holders 7, 7′ which are formed and intended to hold the rechargeable battery cells 1, 2 within the housing 9. As can be gathered from FIG. 4, the cell holders 7, 7′ form a frame in the preferably rectangular or square frame which encircles the rechargeable battery cells 1, 2 from the outside.

According to this preferred exemplary embodiment, each of the cell holders 7, 7′ forms a delimited potting chamber 6, 6′ within which the rechargeable battery cells 1, 2 are surrounded by the thermally conductive potting material. If the cell holders 7, 7′ or the potting chambers 6, 6′ thereof are filled with the potting material, quasi disk-like heat-dissipating elements are formed. The cell holders 7, 7′ preferably have passage openings 3, 3′ which substantially correspond to the outer circumference of the rechargeable battery cells 1, 2. A respective rechargeable battery cell 1, 2 can be pushed into the cell holder 7 through these passage openings 3, 3′ and at the same time closes off the cell holder 7 from the surrounding area. Therefore, disk-like thermally conductive elements are formed when filling the cell holder 7, 7′ or the potting chamber 6, 6′.

Here, the potting chambers 6, 6′ are arranged close to the thermoelectric hotspot of the rechargeable battery cells 1, 2 in order to ensure optimum dissipation of heat.

FIG. 4 likewise shows that, by way of example, precisely two cell holders 7, 7′, which surround approximately 50% of the surface of the rechargeable battery cells 1, 2 with respect to the longitudinal direction LR, are formed in the longitudinal direction LR of the rechargeable battery cells 1, 2.

In a further exemplary embodiment, not illustrated here, four disk-like cell holders of this kind (in the potted state) can be provided in the longitudinal direction LR. In an exemplary embodiment of this kind with four cell holders, a cell holder is preferably arranged at each of the ends of the rechargeable battery cells 1, 2, i.e. in the region of the upper cell connector 5 and also the lower cell connector. Two further cell holders can be arranged approximately in the center, with respect to the length LR.

### LIST OF REFERENCE SIGNS

1 Rechargeable battery cells
2 Rechargeable battery cells
3 Passage openings
3′ Passage openings
5 Cell connector
6 Potting chamber
7 Cell holder
7′ Cell holder
8 Potting material
8′ Potting material
9 Housing
10 Rechargeable battery pack
100 Handheld power tool
LR Longitudinal direction

What is claimed is:

1. A method for manufacturing a rechargeable battery pack for an electric handheld power tool, the rechargeable battery pack having a housing including a plurality of rechargeable battery cells, the rechargeable battery cells being surrounded, at least in sections, by a thermally conductive potting material configured to dissipate heat, the method comprising:
applying the potting material so as to flow around the rechargeable battery cells.

2. The method as recited in claim 1 wherein the plurality of rechargeable battery cells are cylindrical battery cells.

3. The method as recited in claim 1 wherein the potting material has a thermal conductivity of at least 1 W/(m*K).

4. The method as recited in claim 1 wherein the potting material has a UL94 flammability rating of V0.

5. The method as recited in claim 1 wherein the potting material is based on polyurethane.

6. The method as recited in claim 5 wherein the potting material is an elastomer.

7. The method as recited in claim 1 wherein the potting material completely surrounds the rechargeable battery cells.

8. The method as recited in claim 1 further comprising a cell holder holding the rechargeable battery cells within the housing and forming at least one delimited potting chamber, the rechargeable battery cells being surrounded by the thermally conductive potting material within the at least one potting chamber.

9. The method as recited in claim 8 wherein at least one the potting chamber is arranged at a thermoelectric hotspot of at least one of the rechargeable battery cells.

10. The method as recited in claim 1 wherein the rechargeable battery cells are designed as lithium-ion cells or Li-polymer cells.

11. The method as recited in claim 1 wherein the potting material is free of a thermosetting plastic.

12. The method as recited in claim 1 wherein a no-load voltage of the rechargeable battery pack is limited to 60 V DC voltage.

13. The method as recited in claim 1 wherein each of the rechargeable battery cells have two ends and a side extending between the two ends, the potting material covering at least 90% of a length of the side.

14. The method as recited in claim 13 wherein the potting material covers all of the length of the side.

15. The method as recited in claim 1 wherein each of the rechargeable battery cells have two ends and a side extending between the two ends, the potting material covering at least part of the ends.

16. The method as recited in claim 1 wherein each of the battery cells have two ends and a side extending between the two ends and further comprising a cell connector between two of the rechargeable battery cells, the cell connector also being covered by the potting material.

17. The method as recited in claim 1 wherein the potting material is introduced into the housing in liquid form around the rechargeable battery cells and then cured.

18. The method as recited in claim 1 wherein two cell holders are placed within the housing to form a frame encircling the rechargeable battery cells from an outside.

19. The method as recited in claim 18 wherein each of the two cell holders forms a delimited potting chamber filled to allow the rechargeable battery cells to be surrounded by the potting material.

20. The method as recited in claim 17 wherein each of the battery cells have two ends and a side extending between the two ends and further comprising a cell connector between two of the rechargeable battery cells, the cell connector also being covered by the potting material.
